(19) United States
(12) Patent Application Publication
(10) Pub. No.: US 2012/0164201 A1
(43) Pub. Date: Jun. 28, 2012

(54) METHOD OF USING COLLOIDAL SILVER AND GOLD ANTI-MICROBIAL ITEMS TO CREATE CLEAN ZONES THEREWITH

(76) Inventor: Franco Dokmanovich Harris, Pittsburgh, PA (US)

(21) Appl. No.: 13/334,743

(22) Filed: Dec. 22, 2011

Related U.S. Application Data
(60) Provisional application No. 61/426,622, filed on Dec. 23, 2010.

(51) Int. Cl. A01N 25/34; A01P 1/00; A01N 25/08; A01N 59/16; B82Y 99/00

(52) U.S. Cl. 424/402; 424/409; 424/618; 424/649; 977/810; 977/961; 977/904

(57) ABSTRACT

Gelatinous foam, coated paper, fabric, and polymer materials combined with the Colloidal Silver or Gold additive to formulate products with anti-microbial surfaces which will then be installed through a process determined by the owner/operator of a multi-person/multi-use facility (with input from the end user) to create anti-microbial areas within the facility. Embodiments of the present invention can be formed from polymer materials with silver or gold additives for creating bacteria-free anti-microbial areas, known as a Clean Zone™, in multi-use or multi-person facilities, such as gyms, hotels, hospitals, doctors' offices, food courts, restaurants, cruise ships, buses, and airplanes. The various embodiments include coated polymer sheets, polymer trays, bamboo and/or cotton towels, rugs and fabric, polymer foam, or polymer mats containing nano-silver or nano-gold in an scheduled and organized manner (with input/requests from the customer) to create permanent or semi-permanent anti-microbial surfaces.

### CROSS REFERENCE TO RELATED APPLICATIONS

This non-provisional application claims priority from U.S. Provisional Patent Application Ser. No. 61/426,622, entitled COLLOIDAL SILVER AND GOLD ANTI-MICROBIAL CLEAN ZONES AND METHODS FOR MAKING SAME filed on Dec. 23, 2010, which is incorporated herein by reference.

### FIELD OF THE INVENTION

The present invention is related generally to the field of anti-microbial products, and in particular the creation of anti-microbial surfaces through the use of colloidal silver and gold products.

### BACKGROUND OF THE INVENTION

In the areas of physical fitness, hospitality, food service, travel and personal hygiene, the current technology has not addressed the need for substantially sterile surfaces in gyms, dining rooms, cafeterias, food courts, hotel rooms, cruise ships, buses, and other multi-person and multi-use facilities. Those surfaces can be soft or hard, made of gelatinous, foam, coated paper, or other polymer materials, and be permanent, temporary, or removable. The plan for installation of such surfaces will be determined by the owner or operator of the facility, with input from the end-user, with the placement of an item containing colloidal silver or gold anti-microbial particulates.

### SUMMARY OF THE INVENTION

Items containing colloidal silver or gold anti-microbial particulates can include gelatinous, foam, coated paper, fabrics or polymer materials combined with the Colloidal Silver or Gold additive to formulate a product with an anti-microbial surface. The items can include gelatinous materials selected from a group consisting of thermosetting polymer, Styrene-Ethylene-Butadiene-Styrene polymer (SEBS), Thermoplastic Elastomer (TPE), and Polyurethane (PU) gelatin with and without a raised geometry on an outer surface. The foam can be any commercially available foam product including, but not limited to, Polystyrene and Polyurethane. The coated paper may be any commercially available paper product coated with any commercially available paper coating, including but not limited to polyester. The fabric may include, but is not limited to bamboo, cotton, and/or polyester with industrial dye. Other polymer products may be made out of polypropylene or other similar polymers,

Some embodiments of the present invention include polymer materials with hard or soft substantially sterile surfaces to create products such as food trays, and mats and pads that are arranged or placed on surfaces and in rooms to create an anti-microbial area (known as a Clean Zone™) safe for place personal items on without the fear on contamination from bacterial germs. Current technology does not use nano-silver or gold in combination with the materials, embodiments, and processes listed herein to create anti-microbial surfaces. The current technology relies on non-permanent, non-natural anti-microbials chemicals added to polymers which do not last as long.

For a better understanding of the present invention, together with other and further objects thereof, reference is made to the accompanying drawings and detailed description.

### BRIEF DESCRIPTION OF THE DRAWINGS

The present invention is illustratively shown and described in reference to the accompanying drawings, in which:

FIG. 1A is a top view of an anti-microbial towel; and

FIG. 1B is an isometric view of the embodiment of FIG. 1A;

FIG. 2A is a top view of an anti-microbial tray for food, personal hygiene items, or personal instruments; and

FIG. 2B is an isometric view of the alternative embodiment of FIG. 2A.

FIG. 3A is a top view of a rectangular anti-microbial sheet; and

FIG. 3B is an isometric view of the embodiment of FIG. 3A;

FIG. 4A is a top view of an oral anti-microbial sheet; and

FIG. 4B is an isometric view of the alternative embodiment of FIG. 4A;

FIG. 5A is a top view of an anti-microbial bench liner;

FIG. 5B is an isometric view of the alternative anti-microbial bench liner of FIG. 5A;

FIG. 6A-B is a top view of an anti-microbial chair arm liner;

FIG. 6C-D is an isometric view of the alternative anti-microbial chair arm liner of FIG. 6A-B, respectively;

FIG. 7A is a top view of an anti-microbial drawer liner;

FIG. 7B is an isometric view of the alternative anti-microbial drawer liner of FIG. 7A;

FIG. 8A is a top view of an anti-microbial place mat;

FIG. 8B is an isometric view of the alternative anti-microbial place mat of FIG. 8A;

FIG. 9A is a front view of an anti-microbial seat back cover;

FIG. 9B is a top view of an anti-microbial seat bottom cover;

FIG. 9C is an isometric view of the alternative anti-microbial seat covers of FIG. 9A-B;

FIG. 10A-B is a top view of an anti-microbial shower liner;

FIG. 11A-B is a top view of anti-microbial table clothes;

FIG. 11C-D is an isometric view of the alternative anti-microbial seat covers of FIG. 11A-B, respectively; and

FIG. 12 is a process flow diagram illustrating the method to place an anti-microbial item on a surface to be sanitized.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The phrase “cross-linked network” means the one polymer chain is linked or bonded to another polymer chain.

The phrase “monolithic structure” means a solid, single part and not an assembly of two or more components.

The phrase “comprehensively suspended colloidal silver or gold” means silver or gold particulates are suspended evenly throughout the gel or foam, coated paper, fabric or other polymer material or suspended unevenly but along a target surface, such as the outer surface, of the gel or foam, coated paper, fabric or other polymer material, all of which provides sufficient anti-microbial protection for its intended purpose.

Anti-microbial items containing colloidal silver or gold anti-microbial particulates can include gel, foam, coated paper, fabric, or other polymer materials with silver or gold additives for creating anti-microbial areas, known as a “Clean Zone™”, in multi-use or multi-person facilities, such as gyms, hotels, food courts, restaurants, cruise ships, buses, and airplanes. The various embodiments that are placed in a scheduled and organized manner by the owner/operator of the facility (with input/requests from the customer) to create permanent or semi-permanent anti-microbial surfaces include coated paper sheets; coated polymer sheets; polymer trays; bamboo, polyester and/or cotton towels, mats, rugs, and fabric; polymer foam; or polymer mats containing nano-silver or nano-gold.

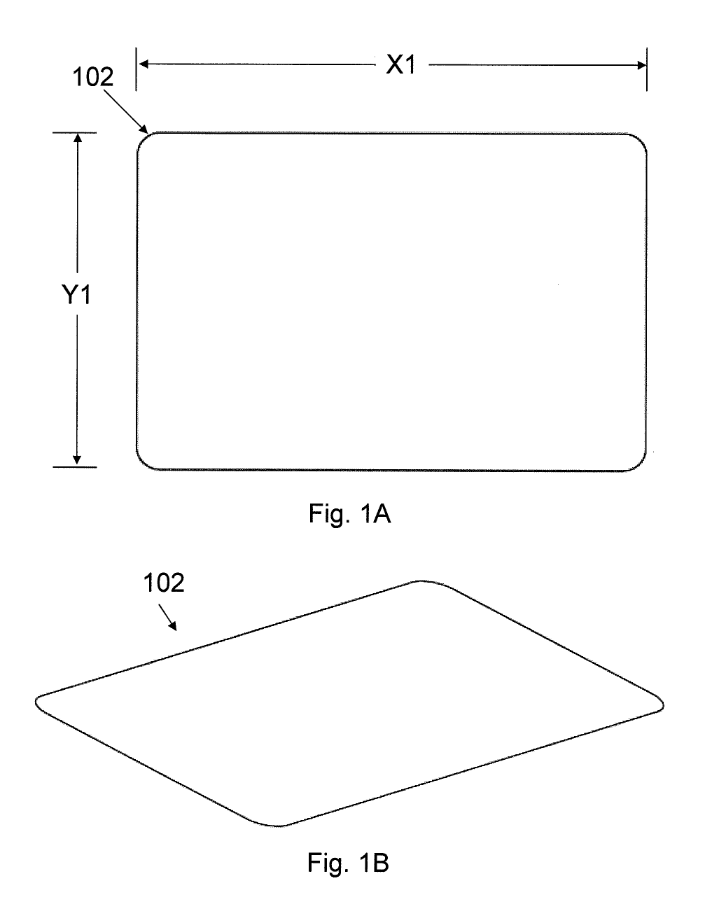

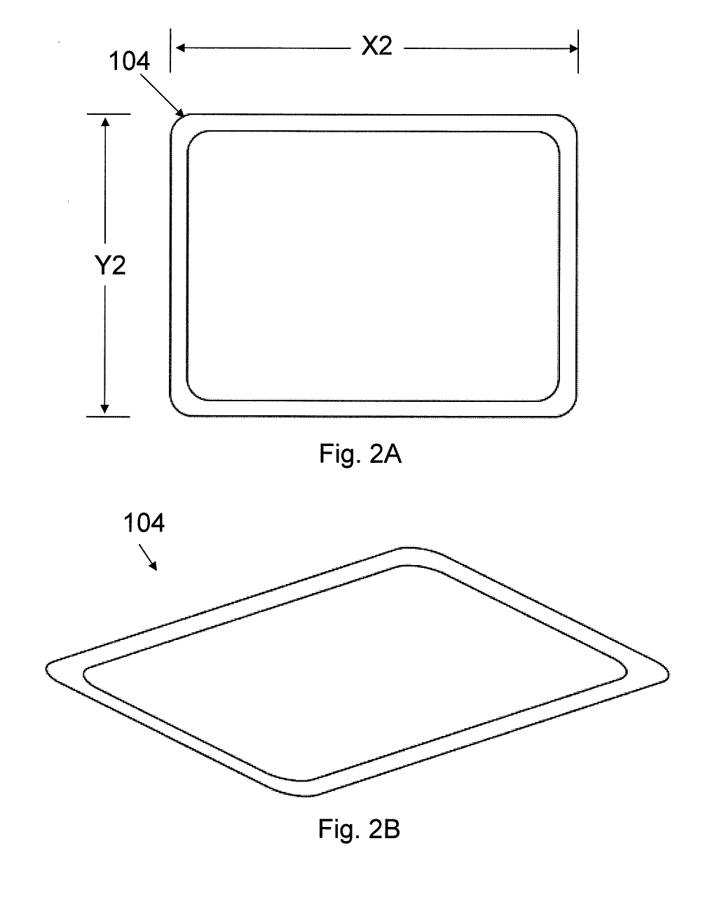

Anti-microbial items of the present invention include a physical surface that can kill existing bacteria and/or prevent the growth of new bacteria. This surface is made of either natural fibers, man-made fibers, paper, or polymers and is treated with an anti-microbial, in particular nano-silver or gold particles, that are either added to the polymer directly, added to the dye used in the production of the fiber products, or added to a coating which is then used to coat the natural fiber, man-made fibers, paper, or polymer products. The present invention embodiment may be designed in a number of shapes and sizes (see FIGS. 1A-B, 3A-B, 4A-B), and may resemble, but are not limited to traditional items such as bath mats, towels, shower curtains, bed linens, drawer liners, bag and luggage liners, trays (see FIGS. 2A-B), place mats, and tablecloths. The present invention embodiment may also be in the form of polymer sheets similar to pieces of paper with or without adhesive on one side for use. The silver or gold concentration of any embodiment formulations of the embodiments disclosed herein are about 200 to about 2000 PPM. For example:

Anti-microbial towels, rugs, carpets, and mats 102 can be made from bamboo, cotton, and/or polyester with industrial dye mixed with nano-silver or gold in a concentration about 200 to about 2000 PPM in the dye. FIGS. 1A-B illustrate the general rectangular shape of the towel 102 having a length X1 and width Y1, wherein the length, width, and thickness (not shown) can be any dimensions to meet customer or user requirements.

Anti-microbial tray 104 can be made of a polypropylene with colorants mixed with nano-silver or gold in a concentration about 200 to about 2000 PPM in the colorants. FIGS. 2A-B illustrate the general rectangular shape, of the tray 104 having a length X2 and width Y2, wherein the length, width, and thickness (not shown) can be any dimensions to meet customer or user requirements.

Clean Zone™ can be created by use of a polyester coated paper stock 106, 108 including nano-silver or gold in a concentration about 200 to about 2000 PPM blended with polyester and applied to the paper as a mixture or the nano-silver or gold blended with a resin solution and coated onto the polyester to form a layered anti-microbial structure on the paper stock.

Liners 106, 108 for items including but not limited to bags or dresser or cabinet drawers includes coated polyester paper stock including nano-silver or gold in a concentration about 200 to about 2000 PPM.

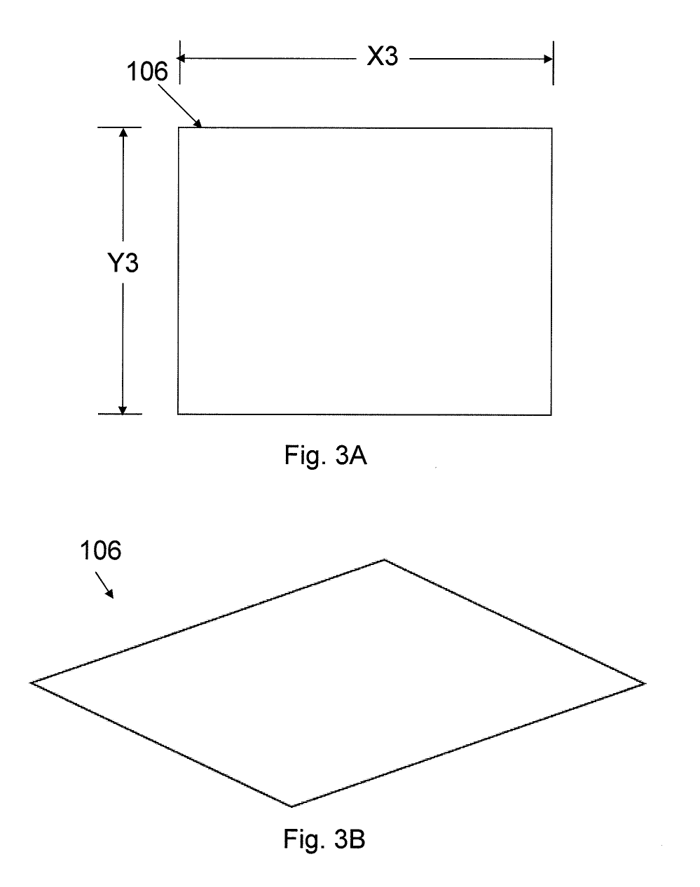

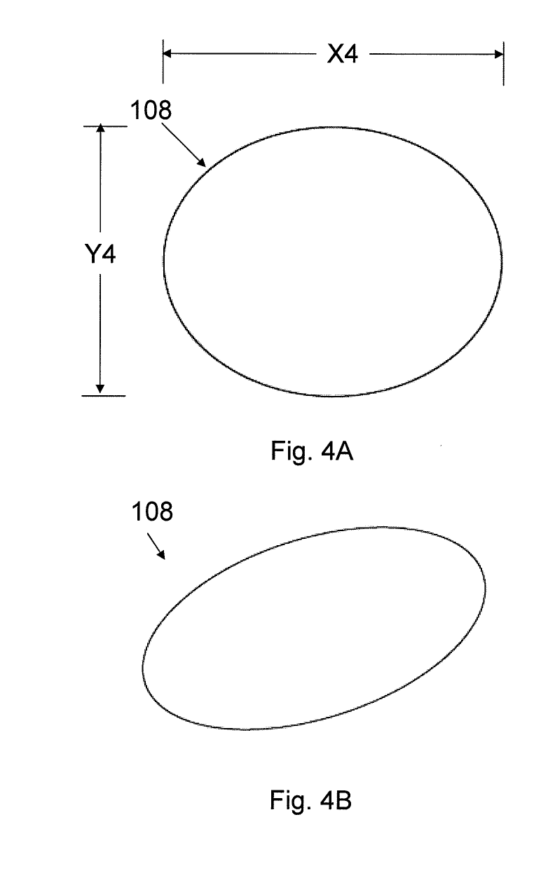

FIGS. 3A-B and 4A-B illustrate the general rectangular and orals shapes, respectively, of the polyester coated paper stock, liners, and other present invention embodiment 106, 108 having a lengths X3, X4 and widths Y3, Y4, respectively, wherein the length, width, and thickness (not shown) can be any dimensions to meet customer or user requirements.

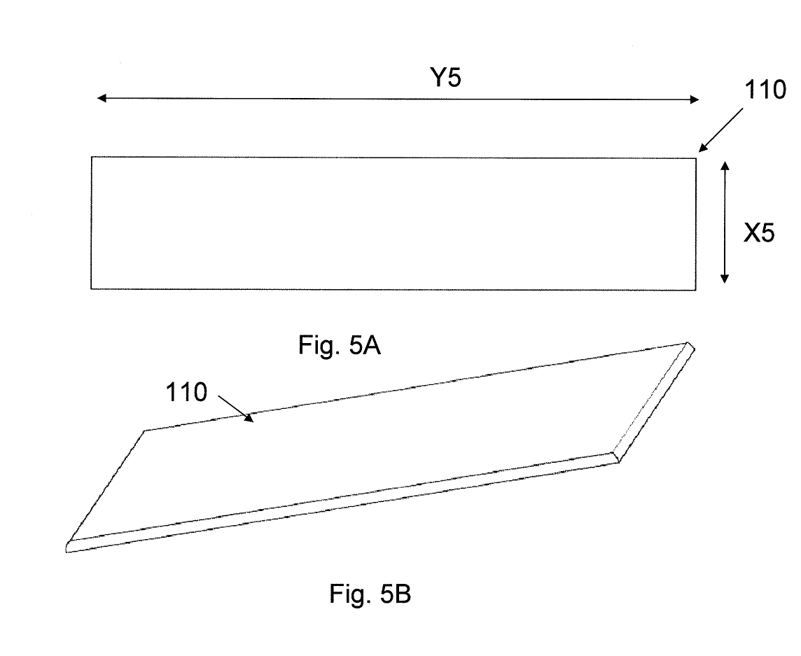

FIGS. 5A-B illustrate the general rectangular shape of a bench of another embodiment of the present invention embodiment 110 having a length X5 and a width Y5 wherein the length, width, and thickness (not shown) can be any dimensions to meet customer or user requirements.

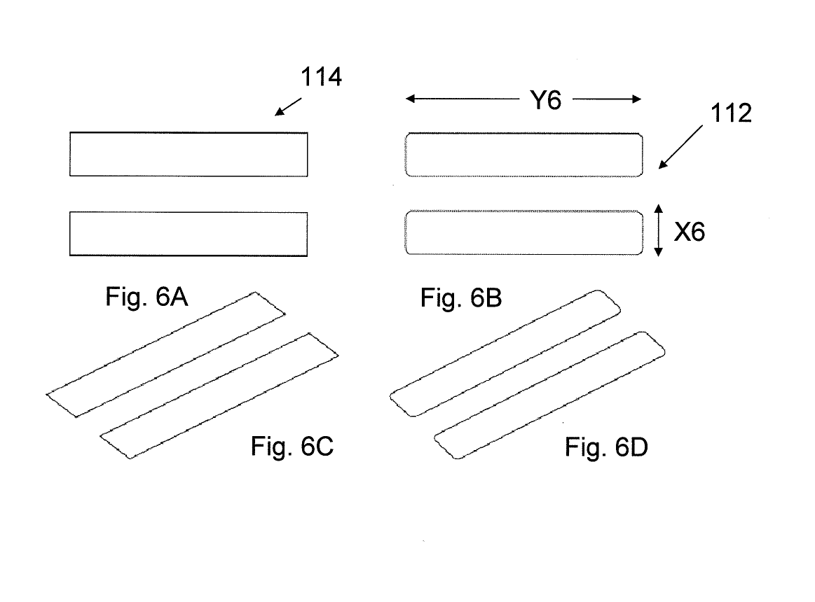

FIGS. 6A-B and 6C-D illustrate the general rectangular shapes of a chair arm liners of another embodiment of the present invention embodiment 112, 114 having lengths X6 and widths Y6, respectively, wherein the length, width, and thickness (not shown) can be any dimensions to meet customer or user requirements. The corners of chair arm liners 112 are rounded. The corners of chair arm liners 114 are square.

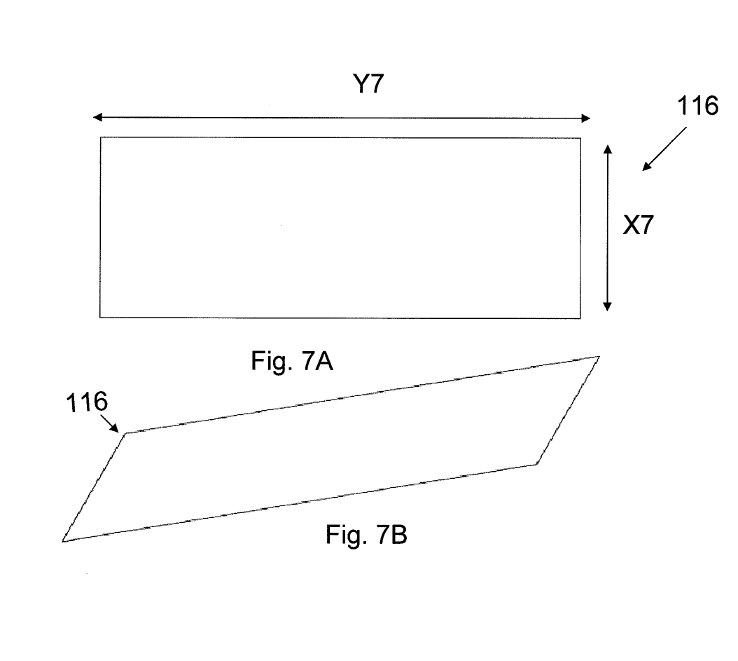

FIGS. 7A-B illustrate the general rectangular shape of a bench of another embodiment of the present invention embodiment 116 having a length X7 and a width Y7 wherein the length, width, and thickness (not shown) can be any dimensions to meet customer or user requirements.

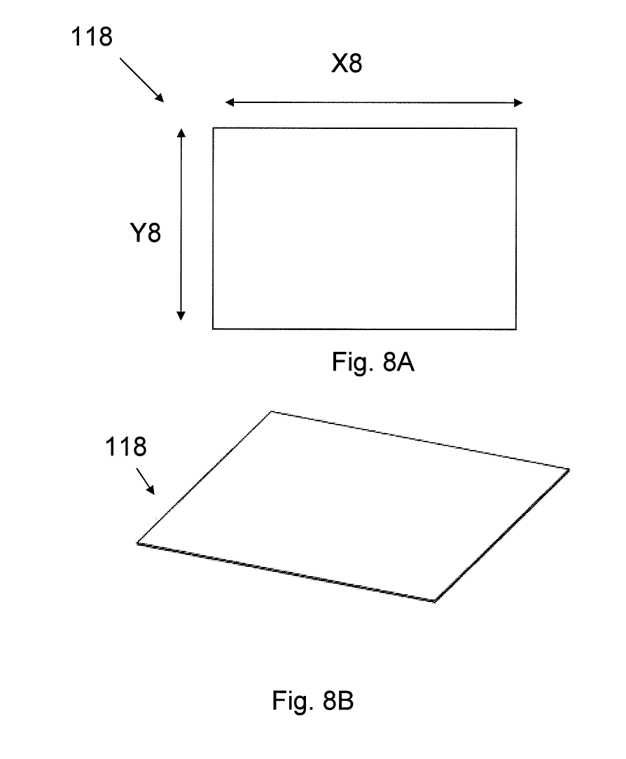

FIGS. 8A-B illustrate the general rectangular shape of a bench of another embodiment of the present invention embodiment 118 having a length X8 and a width Y8 wherein the length, width, and thickness (not shown) can be any dimensions to meet customer or user requirements.

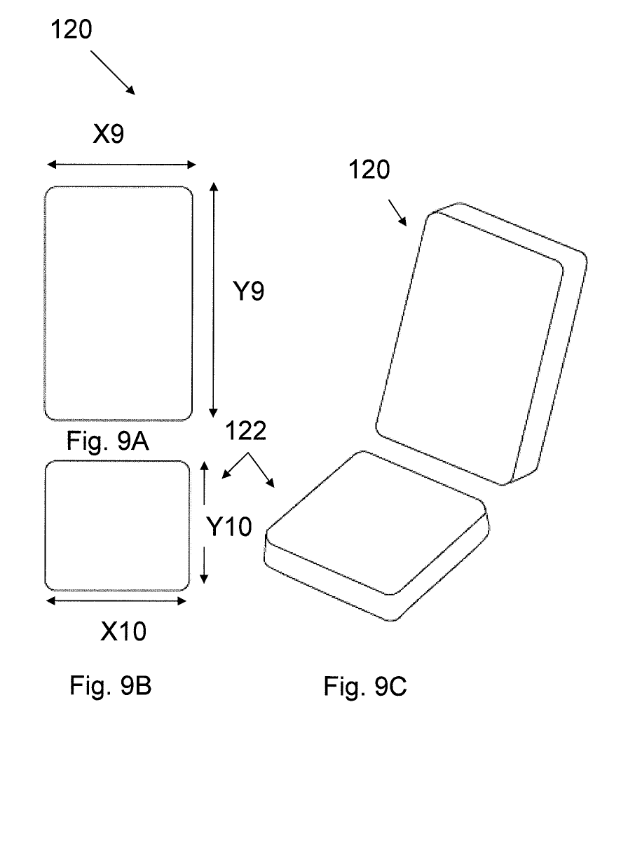

FIGS. 9A-B illustrate the general rectangular shape of a seat back cover and seat bottom cover, respectively, of another embodiment of the present invention embodiment 120, 122 having lengths X9, X10, respectively, and widths Y9, Y10, respectively, wherein the length, width, and thickness (not shown) can be any dimensions to meet customer or user requirements. FIG. 28C is a perspective view of the seat front and seat back relatively placed in position for use.

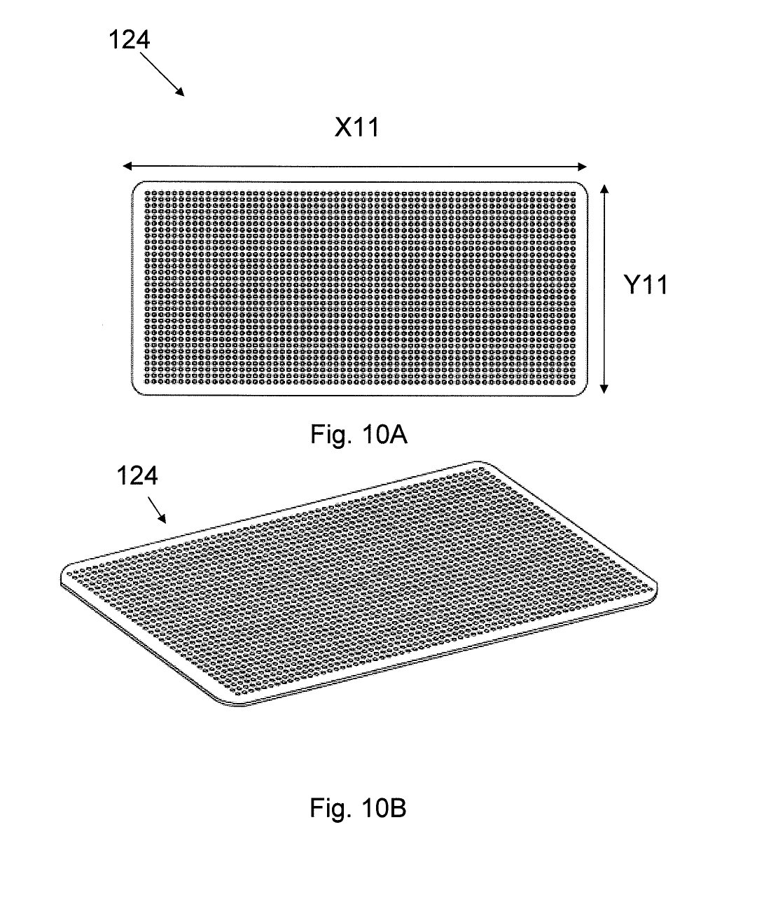

FIGS. 10A-B illustrate the general rectangular shape of a shower liner of another embodiment of the present invention embodiment 124 having a length X11 and a width Y11 wherein the length, width, and thickness (not shown) can be any dimensions to meet customer or user requirements.

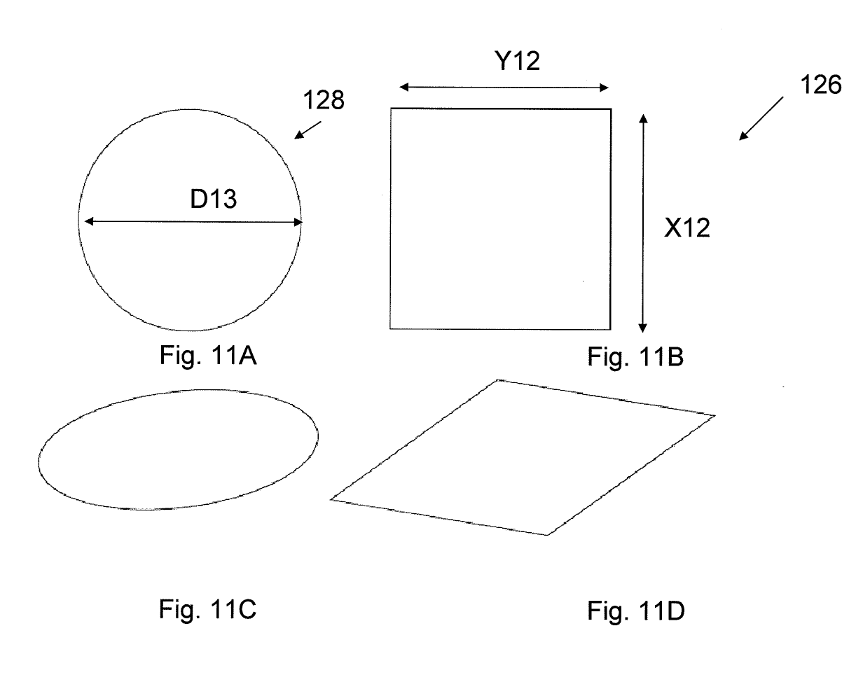

FIGS. 11A-B and 11C-D illustrate the general rectangular and circular shapes, respectively, of the table clothes of another embodiment of the present invention embodiment 126, 128 having a length X12 and a width Y12, and a diameter D13, respectively, wherein the length, width, and thickness (not shown) can be any dimensions to meet customer or user requirements.

Multi-use or multi-person facilities refers to rooms, buildings, and other facilities that are not private homes, including, but is not limited to hotel rooms, gyms, locker rooms, stadiums, hospitals, spas, pools, public bathrooms, food courts, and restaurants. This also includes multi-person mobile facilities such as commercial buses, commercial airplanes, and cruise ships.

A user can be an individual or individuals who employ anti-microbial items discussed above to create the clean zones as anti-microbial areas, including, but is not limited to, hotel guests in a hotel room, athletes in a locker room, diners at a restaurant, or bathroom users in a public bathroom. The use does not have to be intentional or disclosed to the user.

The owner or operator of the facility will designate certain areas within the facilities to be anti-microbial. These areas shall typically include, but not be limited to bathroom countertops, bathroom floors, benches, chairs, tables, closets, drawers, beds, bedroom floors, kitchen countertops, kitchen floors, and entry ways. The user of the facility shall also have the option of specifying additional areas in accordance to owner/operator policy, such as a hotel guest requesting additional clean zones to be installed in their room or a patron placing an embodiment of the present on, for example, a table for a meal. In the case of additional user specification for more clean zones, the owner/operator, employee, or third party shall provide the embodiments of the present invention to the user.

The anti-microbial items can be installed either permanently or temporarily in the specified areas by employees of the owner/operator, the operator/owner, or designated third parties. The installation of the anti-microbial items (also referred to herein as a present invention embodiment) can be done by hand or by machine. The installation of the anti-microbial items can be secured through adhesive, weight, tension, or other methods.

The anti-microbial items can be replaced according to a schedule determined by the owner/operator or the user of the facility. The schedule will be determined through a number of factors, including but not limited to maximizing the bacterial killing properties of the clean zone, cost, types of use of the facility, expected wear and tear to the present invention embodiment, user preference or request, and availability of labor to install the present invention embodiment. This schedule can be changed by the owner/operator as he/she/the organization deems necessary for user health and safety. The user can also remove the present invention at the option of the owner/operator. The present invention can then be replaced by the employees of the owner/operator, the owner/operator, or by a third party.

Creation of anti-microbial area with an anti-microbial additive to the anti-microbial items kills existing and newly added bacteria, and will prevent the growth of new bacteria. The anti-microbial area shall be defined by the size and placement of the present invention, and comprise the entire surface of the present invention. After installation of the present invention embodiment as described above, the part of the facility directly covered by the present invention shall be an anti-microbial area.

As discussed above, businesses, clubs, individuals, and organizations that maintain multi-person or multi-use facilities (such as gyms, hotels, food courts, restaurants, cruise ships) can use the present invention in the form of coated polymer sheets, polymer trays, bamboo and/or cotton towels, rugs, mats and fabric, polymer foam, or polymer mats containing nano-silver or nano-gold in a scheduled and organized manner (with input/requests from the customer) to create permanent or semi-permanent anti-microbial surfaces. The owner/operator of the facility forms a Clean Zone™ plan, which identifies locations that they wish to keep anti-microbial. This plan may include customer/user input. The staff/employees then install the devices in the areas specified by the owner/operator or by the customer. A series of examples includes (i) gym management keeping benches in the locker room free of MRSA and Staph bacteria, (ii) food court management keeping food preparation surfaces, cutting boards, counters, tables, and trays free of bacteria, (iii) hotel operator using the technology to create bacteria-free areas or surfaces around sinks, toilet bowls, bath tubs, showers, counters in their hotel rooms, locker rooms, steam rooms, saunas, hot tubs, a swimming pool, and such areas where bacteria is present. In hospitals and doctors' offices, a Clean Zone can be designated in operating rooms on surgical equipment trays, pre-and post-operative patient recovery areas, examining and patient's rooms on the food/medicine tray, dresser/bureau, railings, bath room areas, door handles/knobs, and other frequently touched surfaces or surfaces where bacteria can grow. Any operator can use the technology to designate and maintain areas to be anti-microbial in any location or any surface material or texture.

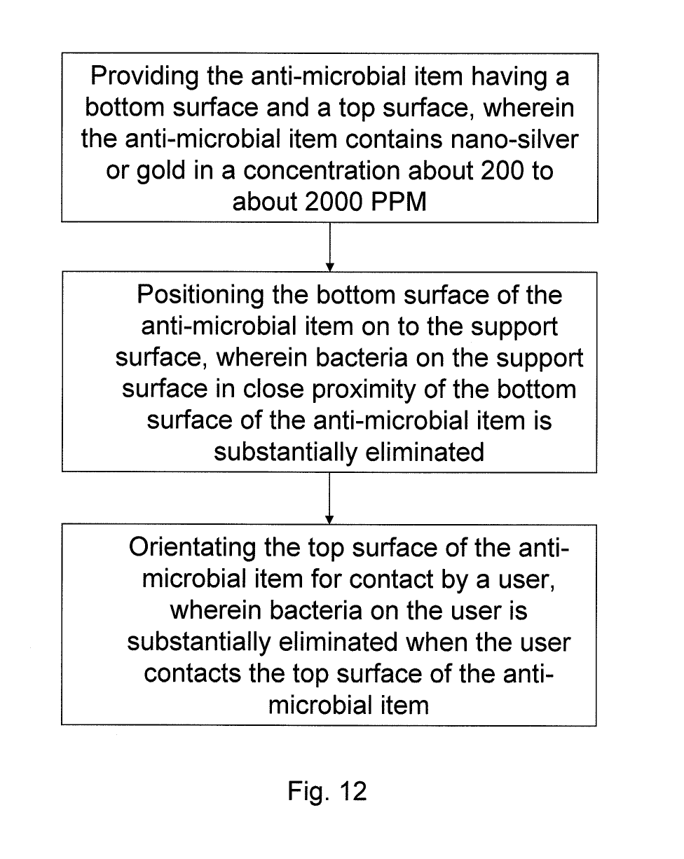

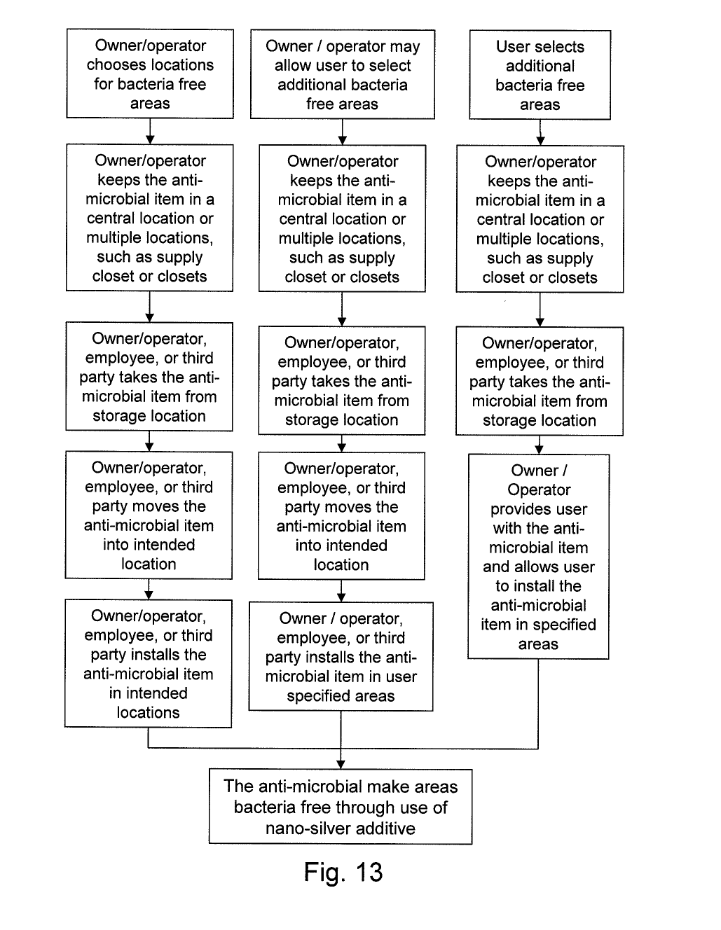

One method of the present invention to use an anti- anti-microbial item includes the following steps and illustrated in FIG. 12:

providing the anti-microbial item having a bottom surface and a top surface, wherein the anti-microbial item contains nano-silver or gold in a concentration about 200 to about 2000 PPM;

positioning the bottom surface of the anti-microbial item on to the support surface, wherein bacteria on the support surface in close proximity of the bottom surface of the anti-microbial item is substantially eliminated; and

orientating the top surface of the anti-microbial item for contact by a user, wherein bacteria on the user is substantially eliminated when the user contacts the top surface of the anti-microbial item,

whereby the sanitary use of the support surface by the user is enhanced in close proximity of the anti-microbial item.

Three alternative embodiments of the present invention to use an anti- anti-microbial item includes the following steps and illustrated in FIG. 13:

The first alternative embodiment of positioning an anti-microbial item to create a bacteria free area includes the steps of:

choosing a location for a bacteria free areas;

storing the anti-microbial item in a central location or multiple locations;

taking the anti-microbial item from the storage location;

moving the anti-microbial item into the bacteria free location; and

installing the anti-microbial item in the location,

whereby the anti-microbial item makes the location substantially bacteria free through use of nano-silver additives in the anti-microbial item.

The second alternative embodiment of positioning an anti-microbial item to create a bacteria free area includes the steps of:

choosing a location for a bacteria free areas by a user;

storing the anti-microbial item in a central location or multiple locations;

taking the anti-microbial item from the storage location;

moving the anti-microbial item into the bacteria free location; and

installing the anti-microbial item in the bacteria free location,

whereby the anti-microbial item makes the bacteria free location substantially bacteria free through use of nano-silver additives in the anti-microbial item.

The third alternative embodiment of positioning an anti-microbial item to create a bacteria free area includes the steps of:

choosing a location for a bacteria free areas by a user;

storing the anti-microbial item in a central location or multiple locations;

taking the anti-microbial item from the storage location;

providing user with the anti-microbial item; and

allowing user to install the anti-microbial item in the bacteria free location,

whereby the anti-microbial item makes the bacteria free location substantially bacteria free through use of nano-silver additives in the anti-microbial item.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method of positioning an anti-microbial item on a support surface to enhance the sanitary use of the support surface and to eliminate bacteria on skin of a user who contacts the anti-microbial item, the method comprising steps of:
providing the anti-microbial item having a bottom surface and a top surface, wherein the anti-microbial item contains nano-silver or gold in a concentration about 200 to about 2000 PPM;
positioning the bottom surface of the anti-microbial item on to the support surface, wherein bacteria on the support surface in close proximity of the bottom surface of the anti-microbial item is substantially eliminated; and
orientating the top surface of the anti-microbial item for contact by the user, wherein bacteria on the user is substantially eliminated when the user contacts the top surface of the anti-microbial item, whereby the sanitary use by the user of the support surface in close proximity of the anti-microbial item is enhanced.

2. The method according to claim 1, wherein the support surface is a sink surface.

3. The method according to claim 1, wherein the support surface is a counter surface.

4. The method according to claim 1, wherein the support surface is a toilet bowl surface.

5. The method according to claim 1, wherein the support surface is a bench surface.

6. The method according to claim 1, wherein the support surface is a table surface.

7. The method according to claim 1, wherein the support surface is a tray surface.

8. The method according to claim 1, wherein the support surface is a shower surface.

9. The method according to claim 1, wherein the support surface is a bath tube surface.

10. The method according to claim 1, wherein the support surface is a cutting board surface.

11. The method according to claim 1, wherein the support surface is a food preparation surface.

12. The method according to claim 1, wherein the support surface is a bench surface.

13. The method according to claim 1, wherein the support surface is a railing.

14. The method according to claim 1, wherein the support surface is a surgical tray.

15. The method according to claim 1, wherein the support surface is in a hospital.

16. The method according to claim 1, wherein the support surface is in a doctor's office.

17. The method according to claim 1, wherein the support surface is in an operating room.

18. The method according to claim 1, wherein the support surface is in pre-and post-operative patient recovery areas, examining or patient's rooms on the food/medicine tray, dresser/bureau, railings, bath room areas, and door handles/knobs.

19. A method of positioning an anti-microbial towel on a support surface to eliminate bacteria on skin of a user who contacts the anti-microbial item, the method comprising steps of:
providing the anti-microbial towel woven with nano-silver or gold fibers with a concentration about 200 to about 2000 PPM; and
positioning the anti-microbial towel on to the support surface in a designated area, wherein bacteria on the user is substantially eliminated when the user contacts the anti-microbial towel.

20. The method according to claim 19, wherein the designated area is a bath room area.

21. The method according to claim 19, wherein the designated area is a locker room area.

22. The method according to claim 19, wherein the designated area is a steam room area.

23. The method according to claim 19, wherein the designated area is a hot tub area.

24. The method according to claim 19, wherein the designated area is a sauna area.

25. The method according to claim 19, wherein the designated area is a swimming pool area.

26. A method of positioning an anti-microbial item to create a bacteria free area, the method comprising steps of:
choosing a location for a bacteria free area;
storing the anti-microbial item in a central location or multiple locations;
taking the anti-microbial item from the storage location;
moving the anti-microbial item into the bacteria free location; and
installing the anti-microbial item in the location,
whereby the anti-microbial item makes the location substantially bacteria free through use of nano-silver additives in the anti-microbial item.

27. A method of positioning an anti-microbial item to create a bacteria free area, the method comprising steps of:
choosing a location for a bacteria free area by a user;
storing the anti-microbial item in a central location or multiple locations;
taking the anti-microbial item from the storage location;
moving the anti-microbial item into the bacteria free location; and
installing the anti-microbial item in the bacteria free location,
whereby the anti-microbial item makes the bacteria free location substantially bacteria free through use of nano-silver additives in the anti-microbial item.

28. A method of positioning an anti-microbial item to create a bacteria free area, the method comprising steps of:
choosing a location for a bacteria free area by a user;
storing the anti-microbial item in a central location or multiple locations;
taking the anti-microbial item from the storage location;
providing user with the anti-microbial item; and
allowing user to install the anti-microbial item in the bacteria free location,
whereby the anti-microbial item makes the bacteria free location substantially bacteria free through use of nano-silver additives in the anti-microbial item.
